(19) United States
(12) Patent Application Publication
(10) Pub. No.: US 2003/0041154 A1
(43) Pub. Date: Feb. 27, 2003

(54) System and method for controlling UNIX group access using LDAP

(76) Inventor: Trung M. Tran, Round Rock, TX (US)

Correspondence Address: B. Noel Kivlin, Conley, Rose & Tayon, P.C., P.O. Box 398, Austin, TX, 78767-0398, US

(21) Appl. No.: 09/938,944

(22) Filed: Aug. 24, 2001

(51) Int. Cl. G06F 15/16

(52) U.S. Cl. 709/229; 709/205

(57) ABSTRACT

A system and method for controlling UNIX group access using an LDAP directory are disclosed. The system and method may be used to overcome a limitation on the size of groups that may be encountered in certain UNIX-based operating systems. A directory may be populated with entries for each of a plurality of users. Each entry in the directory may include information such as a user ID, user password, one or more group names, and optionally one or more hostnames. One or more access control lists may be generated from the directory entries. The operating system may check the access control list(s) to restrict access to the appropriate files or directories (i.e., data sources). For each data source which permits access by a particular group name, access may be granted to the data source to the users in the appropriate group access control list. Likewise, access may be denied to users who are not listed in the appropriate group access control list and who are not otherwise entitled to access (e.g., are not an owner of the data source). Access may include, for example, read, write, and/or execute access.

### BACKGROUND OF THE INVENTION

1. Field of the Invention

The present invention relates generally to computer software. Move particularly, the present invention relates to software for controlling data access privileges in a multi-user environment.

2. Description of the Relevant Art

Secure multi-user computing environments such as UNIX-based operating systems must have the capability to ensure that certain users are restricted from accessing certain data elements. To this end, secure multi-user environments may include a variety of access privilege mechanisms such as file permission schemes. In file systems supported under various flavors of UNIX, for example, each file and directory may be associated with a sequence of permission bits. Each of three categories, of users—the owner of the file or directory, a group associated with the owner, and the rest of the world—may or may not be permitted to read, write, or execute the file or directory. For example, a file whose permissions are listed as “-rwxrw-r--” may be read, written to, and executed by its owner; read and written to but executed by the group; and read but not written to or executed by other users.

The Solaris™ operating system from Sun Microsystems, Inc. is ore such UNIX-based operating system. Presently, Solaris restricts the size of a group to 512K; that is, no more users may be added to the group once the list of users in the group totals approximately 512K. This limitation poses a problem when a user (who is not the owner of a particular file or directory) needs access to a particular file or directory but cannot be added to the relevant group. This problem, of course, is not limited to Solaris and may arise in other computing environments.

One approach to the group size problem would include requesting that a default group for a user be set to a particular sub-group (e.g., for a particular project being pursued by a number of developers) rather than to more general group such as “staff.” However, this solution would not be appropriate where a user belongs to more than one such sub-group (e.g., where the developer needs access to data from more than one project).

Therefore, an improved system and method for establishing and/or controlling group access to data in a multi-user environment is desired.

### SUMMARY OF THE INVENTION

The problems outlined above are in large part solved by various embodiments of a system and method for using a directory such as an LDAP directory to control group access privileges in a file system such as a UNIX file system. The system and method disclosed herein may be used to traverse a group file size problem such as that which may be encountered in Solaris and which is discussed above.

A directory may be populated with entries for each of a plurality of users of a multi-user computing environment. As used herein, a directory or directory server may include a database of information and/or a service that maintains the database, where the information may concern, for example, resources that are available on a network or users in a multi-user computing environment. A multi-user computing environment may include a computer system or operating system which may be used by multiple users, often through the use of multiple user accounts (e.g., a UNIX-based operating system such as Solaris). Populating the directory may include using appropriate commands (such as command-line or GUI-based commands) to enter entries into a directory. In one embodiment, each entry in the directory may include information such as a user ID, user password, and one or more group names. The password may be used for authenticating the associated user IDs. In one embodiment, a directory entry may optionally include one or more hostnames. A hostname indicates a host computing system from which a user may access a data source.

One or more access control lists may be generated from the directory entries. The access control list(s) may be stored in a file system coupled to the multi-user computing environment. As used herein, an access control list may include one or more logical files and one or more group access control lists which are specific to a particular group of users. For example, a first group access control list may be determined for a first one of the group names in the directory, wherein the first group access control list comprises the user IDs of users whose directory entries comprise the first group name.

In one embodiment, the operating system may check the access control list(s) to restrict access to the appropriate files or directories (i.e., data sources). For each data source in the multi-user computing environment which permits access by a particular group name, access may be granted to the data source to the users in the appropriate group access control list. Likewise, access may be denied to users who are not listed in the appropriate group access control list and who are not otherwise entitled to access (e.g., are not an owner of the data source). Access may include, for example, read, write, and/or execute access. The data source may include a file, a directory, or other form of information in a file system coupled to the multi-user computing environment. A file system may include a mechanism for storing and retrieving such information.

Where directory entries include hostnames, for each data source in the multi-user computing environment which permits access by the first host name, access may be granted to the data source to the one or more users whose directory entries comprise the first host name and who are seeking access from the host having the first host name.

### BRIEF DESCRIPTION OF THE DRAWINGS

Other objects and advantages of the invention will become apparent upon reading the following detailed description and upon reference to the accompanying drawings in which:

FIG. 1 illustrates a computer system which is suitable for implementing a group access privileges system and method according to several embodiments.

FIG. 2 is a block diagram of the computer system of FIG. 1 which is suitable for implementing a group access privileges system and method according to several embodiments.

FIG. 3 illustrates an enterprise computing environment which is suitable for implementing a group access privileges system and method according to several embodiments.

FIG. 4 is an illustration of a file system having access privileges according to one embodiment.

FIG. 5 is an illustration of sample directory entries for controlling, group access privileges for a file system according to one embodiment.

FIG. 6 is a flowchart showing a method for using a directory to control group access privileges for a file system according to one embodiment.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

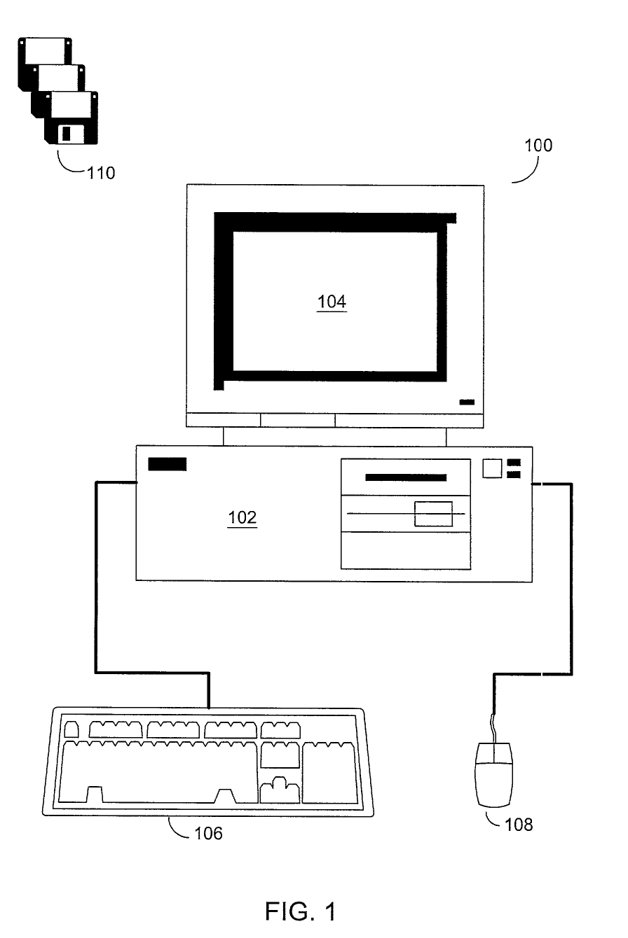

### FIG. 1—A Typical Computer System

FIG. 1 illustrates a typical, general-purpose computer system 100 which is suitable for implementing a group access privileges system and method according to one embodiment. The computer system 100 typically comprises components such as computing hardware 102, a display device such as a monitor 104, an alphanumeric input device such as a keyboard 106, and optionally an input device such as a mouse 108. The computer system 100 is operable to execute computer programs which may be stored on disks 110 or in computing hardware 102. In various embodiments, the computer system 100 may comprise a desktop computer, a laptop computer, a palmtop computer, a network computer, a personal digital assistant (PDA), an embedded device, a smart phone, or any other suitable computing device.

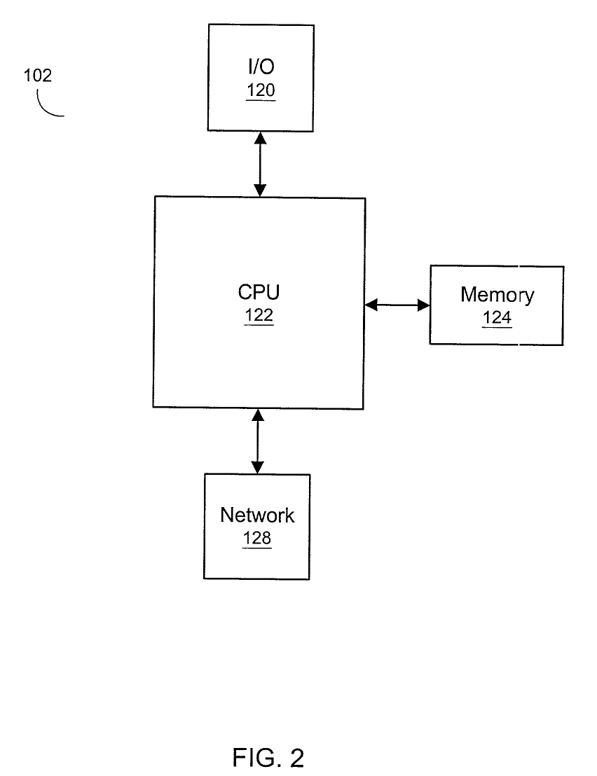

### FIG. 2—Computing Hardware of a Typical Computer System

FIG. 2 is a block diagram illustrating the computing hardware 102 of a typical, general-purpose computer system 100 which is suitable for implementing a group access privileges system and method according to one embodiment. The computing hardware 102 includes at least one central processing unit (CPU) or other processor(s) 122. The CPU 122 may be configured to execute program instructions which implement the group access privileges system and method as described herein. The CPU 122 is preferably coupled to a memory medium 124.

As used herein, the term “memory medium” includes a non-volatile medium, e.g., a magnetic medium, hard disk, or optical storage; a volatile medium, such as computer system memory, e.g., random access memory (RAM) such as DRAM, SDRAM, SRAM, EDO RAM, Rambus RAM, etc.; or an installation medium, such as CD-ROM, floppy disks, or a removable disk, on which computer programs are stored for loading into the computer system. The term “memory medium” may also include other types of memory.

The memory medium 124 may therefore store program instructions and/or data which implement the improved management console as described herein. Furthermore, the memory medium 124 may be utilized to install the program instructions and/or data. In a further embodiment, the memory medium 124 may be comprised in a second computer system which is coupled to the computer system 100 through a network, 128. In this instance, the second computer system may operate to provide the program instructions stored in the memory medium 124 through the network 128 to the computer system 100 for execution.

The CPU 122 may also be coupled through an input/output bus 120 to one or more input/output devices that may include, but are not limited to, a display device such as a monitor 104, a pointing device such as a mouse 108, a keyboard 106, a track ball, a microphone, a touch-sensitive display, a magnetic or paper tape reader, a tablet, a stylus, a voice recognizer, a handwriting recognizer, a printer, a plotter, a scanner, and any other devices for input and/or output. The computer system 100 may acquire program instructions and/or data for implementing the group access privileges system and method as described herein through the input/output bus 120.

The CPU 122 may include a network interface device 128 for coupling to a network. The network may be representative of various types of possible networks: for example, a local area network (LAN), wide area network (WAN), or the Internet. The improved management console as described herein may therefore be implemented on a plurality of heterogeneous or homogeneous networked computer systems such as computer system 100 through one or more networks. Each computer system 100 may acquire program instructions and/or data for implementing the group access privileges system and method as described herein over the network.

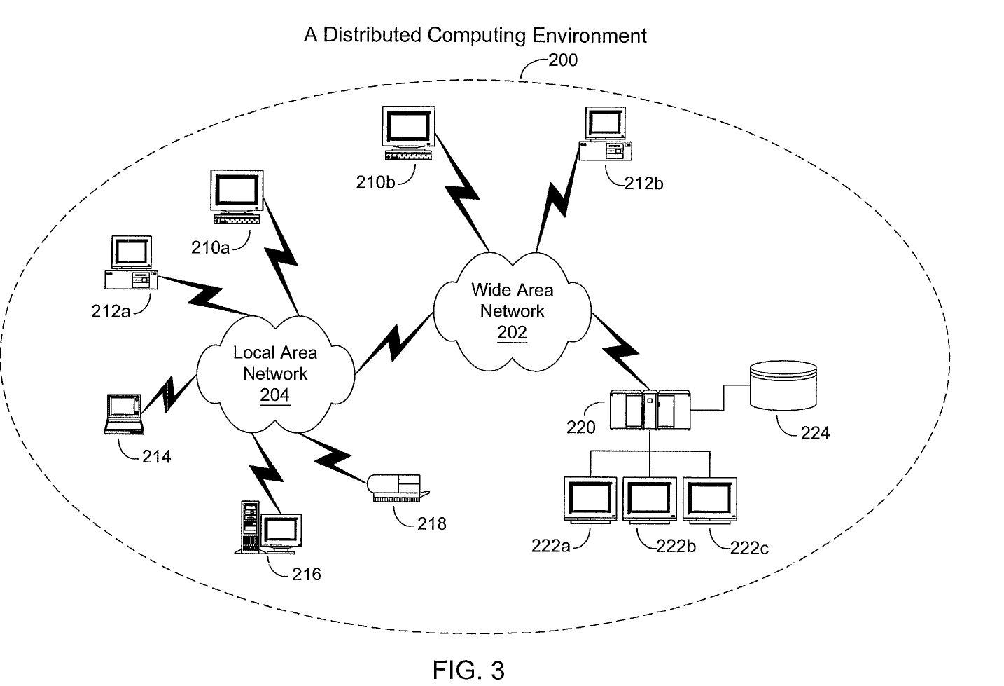

### FIG. 3—A Typical Distributed Computing Environment

FIG. 3 illustrates a distributed or enterprise computing environment 200 according to one embodiment. An enterprise 200 may include a plurality of computer systems such as computer system 100 which are interconnected through one or more networks. Although one particular embodiment is shown in FIG. 3, the enterprise 200 may comprise a variety of heterogeneous computer systems and networks which are interconnected in a variety of ways and which run a variety of software applications.

One or more local area networks (LANs) 204 may be included in the enterprise 200. A LAN 204 is a network that spans a relatively small area. Typically, a LAN 204 is confined to a single building or group of buildings. Each node (i.e., individual computer system or device) on a LAN 204 preferably has its own CPU with which it executes computer programs, and often each node is also able to access data and devices anywhere on the LAN 204. The LAN 204 thus allows many users to share devices (e.g., printers) as well as data stored on file servers. The LAN 204 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves). FIG. 3 illustrate an enterprise 200 including one LAN 204. However, the enterprise 200 may include a plurality of LANs 204 which are coupled to one another through a wide area network (WAN) 202. A WAN 202 is a network that spans a relatively large geographical area.

Each LAN 204 comprises a plurality of interconnected computer systems or at least one computer system and at least one other device. Computer systems and devices which may be interconnected through the LAN 204 may include, for example, one or more of a workstation 210a, a personal computer 212a, a laptop or notebook computer system 214, a server computer system 216, or a network printer 218. An example LAN 204 illustrated in FIG. 3 comprises one of each of these computer systems 210a, 212a, 214, and 216 and one printer 218. Each of the computer systems 210a, 212a, 214, and 216 is preferably an example of the typical computer system 100 as illustrated in FIGS. 1 and 2. The LAN 204 may be coupled to other computer systems and/or other devices and/or other LANs 204 through a WAN 202.

A mainframe computer system 220 may optionally be coupled to the enterprise 200. As shown in FIG. 3, the mainframe 220 is coupled to the enterprise 200 through the WAN 202, but alternatively the mainframe 220 may be coupled to the enterprise 200 through a LAN 204. As shown in FIG. 3, the mainframe 220 is coupled to a storage device or file server 224 and mainframe terminals 222a, 222b, and 222c. The mainframe terminals 222a, 222b, and 222c access data stored in the storage device or file server 224 coupled to or comprised in the mainframe computer system 220.

The enterprise 200 may also comprise one or more computer systems which are connected to the enterprise 200 through the WAN 202: as illustrated, a workstation 210b and a personal computer 212b. In other words, the enterprise 200 may optionally include one or more computer systems which are not coupled to the enterprise 200 through a LAN 204. For example, the enterprise 200 may include computer systems which are geographically remote and connected to the enterprise 200 through the Internet.

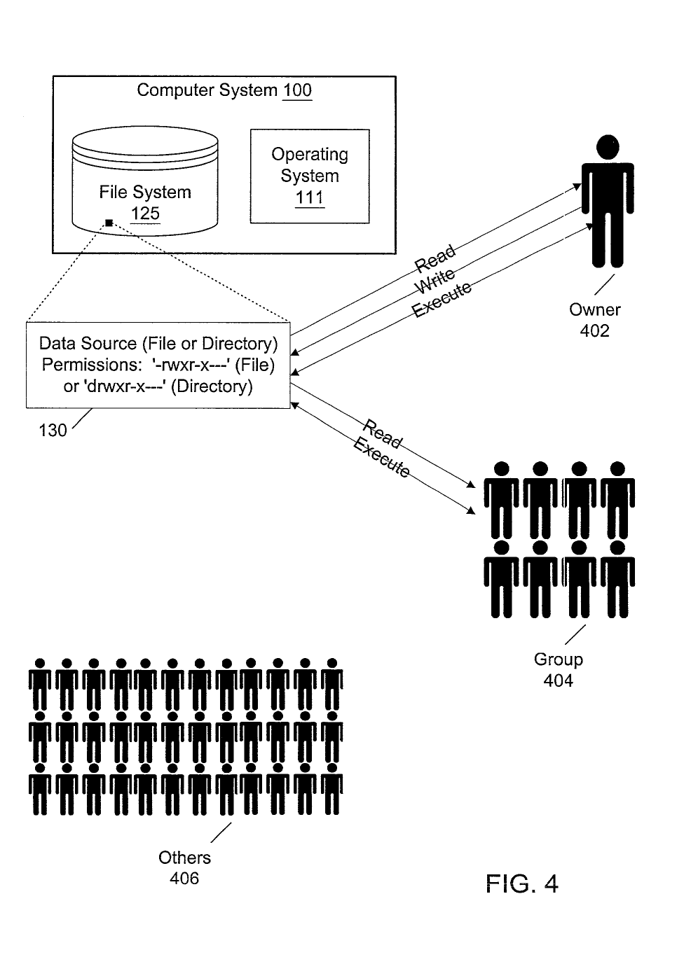

### FIG. 4—An Example File System Including Access Privileges

FIG. 4 is an illustration of a file system having access privileges according to one embodiment. The computer system 100 includes an operating system 111 which may provide access to the file system 125 (which is logically included 111 or coupled to the computer system 100) for users and other programs. The operating system 111 may include a multi-user operating system such as a UNIX-based operating system. A multi-user operating system may permit access to the computer system 100 by multiple users, such as by maintaining an account for each user. In one embodiment, the operating system 111 is a version of the Solaris™ operating system available from Sun Microsystems, Inc.

The file system 125 may include one or more physical devices which may be located locally or remotely. The file system 111 may include files and directories. As used herein, a “data source” includes files, directories, and any other suitable form of information that may be stored by a file system. An example data source 130 is shown.

The operating system 125 may include one or more mechanisms for restricting access to the file system In one embodiment, such as a UNIX-based embodiment, the file system security scheme may include labeling data sources with permission bits which denote access privileges for particular classes of users. For example, the permission bits for the example data source may be “-rwxr-x---” if the data source is a file or “drwxr-x---” if the data source is a directory (where the initial ‘d’ indicates that the data source is a directory). In this instance, the data source may be read, written to, or executed by its owner 402; read and executed by but not written to by members of a designated group 404; and inaccessible to others 406 (that is, anyone other than the owner 402 and the group members 404).

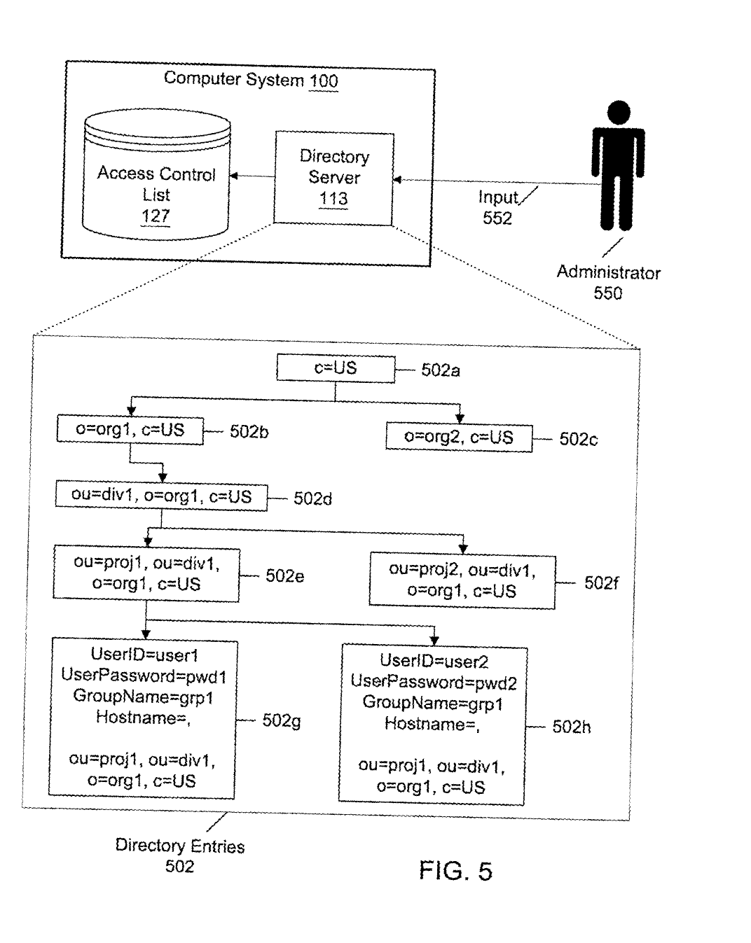

### FIG. 5—An Example Directory

FIG. 5 is an illustration of sample directory entries for controlling group access privileges for a file system according to one embodiment. The computer system 100 may include a directory server 113 such as an LDAP server. The Lightweight Directory Access Protocol (LDAP) provided an industry-standard interface for accessing data stored in an LDAP-compliant directory. LDAP may include naming, information, access, and security models for storing and protecting data.

In one embodiment, the basic LDAP storage unit includes the directory entry, which is where information about a particular object resides. An object may include a collection of attributes which each have a corresponding value. What attributes an object may contain is defined in an object class. For example, to describe a person, an object of object class “person” may be created. The “person” object class may define a set of attributes, like first name, surname, and telephone number, which describes the person whose directory entry is being created. To maintain order, a set of rules may be established to govern which attributes are required, which ones are optional, and what type of data can be stored in them. This set of rules is called the directory schema. To promote interoperability between different vendors' LDAP servers, a well-defined standard schema exists and is expected to be included on all LDAP servers.

An administrator 550 may input information 552 into the directory server 113 using one or more commands which may be entered at the command line or through an appropriate graphical interface. For example, the commands “└dapadd” and “ldapmodify” may be used to open a connection to an LDAP server 113 and bind, modify, or add entries. The command “ldapdelete” may be used to open a connection to the LDAP server 113 and bind, modify, or delete entries.

Example directory entries 502 are shown in FIG. 5. In one embodiment, an entry may be identified by its distinguished name (DN), which is similar to an absolute pathname in a file system. The main difference is that the DN is typically specified in the reverse order of a pathname. Information (as entries) may be ordered in a hierarchical structure called a Directory Information Tree (DIT). In the example, a top-level entry 502a specifying a high-level organizational category such as country (in this case, the United States) may be included in the server 113. In other embodiments, however, thus top-level entry may not exist: a directory server may include no root directory which serves as an entry point into the entire structure. Instead, a directory may contain one or more suffixes which signify the top node of a DIT. Under each suffix may be a separate DIT which provides its own namespace. Each directory server may include an entry called a Directory Specific Entry (DSE) which contains information pertinent to the directory server but is not connected to any of the DITs.

The example entries 502 may include two organizations 502b and 502c. Entry 502d may denote an organizational unit, such as a division, underneath the first organization 502b. Under the division 502d are two projects 502e and 502f. As explained in relation to entry 502a, these high-level entries 502b, 502c, 502d, 502e, and/or 502f may not exist in the server; however, they are included here to show the logical structure of the directory.

To solve the group size limit problem discussed above, each user may be constructed as a directory entry in a directory of indefinite size. In the example, two such users are shown as entries 502g and 502h. The user entries may include information such as the user ID, user password, group name(s), and host name(s). The user ID may include a UNIX account name, or some other suitable identifier, for a particular user. The user password may be used for authentication purposes. The group names may be used to control access to group data sources (as explained in further detail below) The optional hostname attribute may be used to control which hostnames are able to access the group regardless of whether or not the accessing user's ID is in the ACL. In one embodiment, the user ID, group name(s), and hostname(s) may be stored as text (e.g., ASCII text), and the password may be stored as binary data (e.g., for ease of encryption).

An access control list (ACL) 127 may be generated from the information in the directory server. In one embodiment, the ACL may have no size limitation (except, of course, for the storage capacity of the file system 125). In one embodiment, the operating system 125 may check the ACL 127 to determine whether a user or group has access to a particular data source. Therefore, the ACL 127 may be used to supplement or replace the file permissions scheme shown in FIG. 4.

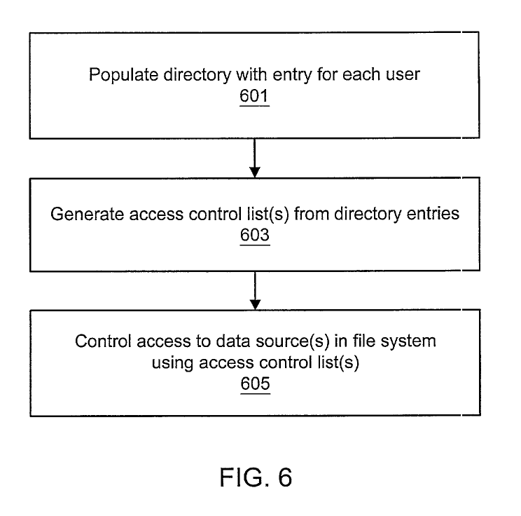

### FIG. 6—A Method for Using a Directory to Control Access Privileges

FIG. 6 is a flowchart showing a method for using a directory to control group access privileges for a file system according to one embodiment. This method may be used to traverse a group file size problem such as that which may be (encountered in Solaris and which is discussed above.

In 601, a directory may be populated with entries for each of a plurality of users of a multi-user computing environment. As used herein, a directory or directory server may include a database of information and/or a service that maintains the database, where the information may concern, for example, resources that are available on a network or users in a multi-user computing environment. A multi-user computing environment may include a computer system or operating system which may be used by multiple users, often through the use of multiple user accounts (e.g., a UNIX-based operating system such as Solaris). Populating the directory may include using appropriate commands (such as command-line or GUI-based commands) to enter entries into a directory. In one embodiment, each entry in the directory may include information such as a user ID, user password, and one or more group names. The password may be used for authenticating the associated user IDs. In one embodiment, a directory entry may optionally include one or more hostnames. A hostname indicates a host computing system from which a user may access a data source.

In 603, one or more access control lists may be generated from the directory entries 502. The access control list(s) may be stored in a file system coupled to the multi-user computing environment. As used herein, an access control list may include one or more logical files and one or more group access control lists which are specific to a particular group of users. For example, a first group access control list may be determined for a first one of the group names in the directory, wherein the first group access control list comprises the user IDs of users whose directory entries comprise the first group name.

In 605, for each data source in the multi-user computing environment which permits access by a particular group name, access may be granted to the data source to the users in the appropriate group access control list. Likewise, access may be denied to users who are not listed in the appropriate group access control list and who are not otherwise entitled to access (e.g., are not an owner of the data source). Access may include, for example, read, write, and/or execute access. The data source may include a file, a directory, or other form of information in a file system coupled to the multi-user computing environment. A file system may include a mechanism for storing and retrieving such information.

Where directory entries include hostnames, for each data source in the multi-user computing environment which permits access by the first host name, access may be granted to the data source to the one or more users whose directory entries comprise the first host name and who are seeking access from the host having the first host name.

Various embodiments may further include receiving or storing instructions and/or data implemented in accordance with the foregoing description upon a carrier medium. Suitable carrier media may include storage media or memory media such as magnetic or optical media, e.g., disk or CD-ROM, as well as transmission media or signals such as electrical, electromagnetic, or digital signals, conveyed via a communication medium such as a network and/or a wireless link.

While the present invention has been described with reference to particular embodiments, it will be understood that the embodiments are illustrated and that the invention scope is not so limited. Any variations, modifications, additions and improvements to the embodiments described are possible. These variations, modifications, additions and improvements may fall within the scope of the invention as detailed within the following claims.

What is claimed is:

1. A method comprising:
populating a directory with entries for each of a plurality of users of a multi-user computing environment, wherein each entry in the directory comprises a user ID and one or more group names;
determining a first group access control list for a first one of the group names in the directory, wherein the first group access control list comprises the user IDs of users whose directory entries comprise the first group name;
for each data source in the multi-user computing environment which permits access by the first group name, granting access to the data source to the users in the first group access control list.

2. The method of claim 1,
wherein each entry in the directory comprises a user password; and
wherein the method further comprises authenticating each user ID using the associated user password.

3. The method of claim 1,
wherein each entry in the directory comprises zero, one, or a plurality of hostnames;
wherein the directory comprises a first hostname; and
wherein the method further comprises:
for each data source in the multi-user computing environment which permits access by the first hostname, granting access to the data source to the one or more users whose directory entries comprise the first hostname and who are seeking access from the host having the first hostname.

4. The method of claim 1,
wherein the data source comprises a file or a directory in a file system coupled to the multi-user computing environment.

5. The method of claim 1,
wherein the access comprises read access; and
wherein the granting access to the data source to the users in the first group access control list comprises permitting the users in the first group access control list to read the data source.

6. The method of claim 1,
wherein the access comprises write access; and
wherein the granting access to the data source to the users in the first group access control list comprises permitting the users in the first group access control list to write to the data source.

7. The method of claim 1,
wherein the access comprises execute access; and
wherein the granting access to the data source to the users in the first group access control list comprises permitting the users in the first group access control list to execute the data source.

8. The method of claim 1,
for each data source in the multi-user computing environment which permits access by the first group name and owner but denies access to others, denying access to the data source to users who are not in the first group access control list and who are not the owner of the data source.

9. The method of claim 1,
wherein the multi-user computing environment comprises a UNIX-based operating system.

10. A system comprising:
a file system which comprises one or more data sources including a first data source;
a directory server which is operable to store a plurality of directory entries for a plurality of users, wherein each directory entry comprises a user ID and one or more group names which denote groups to which the user ID belongs, wherein at least one of the directory entries comprises a first group name; and
a first group access control list which is generated from the directory entries, wherein the first group access control list comprises the at least one user IDs belonging to the first group name, and wherein the first group access control list is usable to permit access to the first data source to user IDs belonging to the first group name.

11. The system of claim 10,
wherein each entry in the directory comprises a user password, wherein the user password is usable to authenticate the corresponding user ID) for access to the one or more data sources.

12. The system of claim 10, further comprising:
a host computer system coupled to the file system;
wherein each entry in the directory comprises zero, one, or a plurality of host names such that the directory server comprises a first host name corresponding to the host computer system, and wherein access is granted to the first data sources to users seeking access from the host computer system.

13. The system of claim 10,
wherein the access to the first data source comprises read access.

14. The system of claim 10,
wherein the access to the first data source comprises write access.

15. The system of claim 10,
wherein the access to the first data source comprises execute access.

16. The system of claim 10, further comprising:
an operating system which is operable to restrict user access to the data sources in the file system.

17. A carrier medium comprising program instructions which are computer-executable to implement:
populating a directory with entries for each of a plurality of users of a multi-user computing environment, wherein each entry in the directory comprises a user ID and one or more group names;
determining a first group access control list for a first one of the group names in the directory, wherein the first group access control list comprises the user IDs of users whose directory entries comprise the first group name;
for each data source in the multi-user computing environment which permits access by the first group name, granting access to the data source to the users in the first group access control list.

18. The carrier medium of claim 17,
wherein each entry in the directory comprises a user password; and
wherein the program instructions are further computer-executable to implement authenticating each user ID using the associated user password.

19. The carrier medium of claim 17,
wherein each entry in the directory comprises zero, one, or a plurality of hostnames;
wherein the directory comprises a first hostname; and
wherein the program instructions are further computer-executable to implement:
for each data source in the multi-user computing environment which permits access by the first hostname, granting access to the data source to the one or more users whose directory entries comprise the first hostname and who are seeking access from the host having the first hostname.

20. The carrier medium of claim 17,
wherein the data source comprises a file or a directory in a file system coupled to the multi-user computing environment.

21. The carrier medium of claim 17,
wherein the access comprises read access; and
wherein the granting access to the data source to the users in the first group access control list comprises permitting the users in the first group access control list to read the data source.

22. The carrier medium of claim 17,
wherein the access comprises write access; and
wherein the granting access to the data source to the users in the first group access control list comprises permitting the users in the first group access control list to write to the data source.

23. The carrier medium of claim 17,
wherein the access comprises execute access; and
wherein the granting access to the data source to the users in the first group access control list comprises permitting the users in the first group access control list to execute the data source.

24. The carrier medium of claim 17, wherein the program instructions are further computer-executable to implement:
for each data source in the multi-user computing environment which permits access by the first group name and owner but denies access to others, denying access to the data source to users who are not in the first group access control list and who are not the owner of the data source.

25. The carrier medium of claim 17,
wherein the multi-user computing environment comprises a UNIX-based operating system.
